(19) United States
(12) Patent Application Publication
(10) Pub. No.: US 2025/0119550 A1
(43) Pub. Date: Apr. 10, 2025

(54) SEARCH AREA AND TEMPLATE MATCHING COST FOR TEMPLATE MATCHING TOOLS IN VIDEO CODING

(71) Applicant: QUALCOMM Incorporated, San Diego, CA (US)

(72) Inventors: Gleb Verba, Munich (DE); Zhi Zhang, Munich (DE); Vadim Seregin, San Diego, CA (US); Marta Karczewicz, San Diego, CA (US)

(21) Appl. No.: 18/905,763

(22) Filed: Oct. 3, 2024

Related U.S. Application Data
(60) Provisional application No. 63/588,576, filed on Oct. 6, 2023.

(51) Int. Cl. H04N 19/137; H04N 19/176

(52) U.S. Cl. CPC H04N 19/137; H04N 19/176

(57) ABSTRACT

A method of decoding video data includes determining a predefined search area that is predefined based on dimensions of a current block within a current picture; determining one or more block vectors; determining one or more additional search areas based on the one or more block vectors; determining a prediction block for the current block based on the predefined search area and the one or more additional search areas; and reconstructing the current block based on the prediction block.

This application claims the benefit of U.S. Provisional Patent Application 63/588,576, filed Oct. 6, 2023, the entire contents of which is incorporated herein by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for template matching in video coding. In template matching, a video coder (e.g., video encoder or video decoder) determines templates (e.g., reference templates) within a search range (e.g., search area) and determines respective costs associated with respective templates for video coding (e.g., determining a prediction block for a current block). This disclosure describes example techniques of determining the search area and determining costs in a manner that allows for a larger search area while reducing impact of computational complexity associated with larger search area and cost computations. In this manner, the example techniques may improve the overall operation of video coding techniques by integrating the example techniques into the practical application of template matching in video coding.

In one or more examples, a video encoder and a video decoder may determine a predefined search area that is predefined based on dimensions of a current block. The video encoder and the video decoder may also determine one or more additional search areas based on one or more block vectors, where the block vectors identify samples in the same picture as the current block. The block vectors may be block vector predictors for the current block, such as block vectors of neighboring blocks to the current block.

The video encoder and the video decoder may perform template matching within the predefined search area and the one or more additional search areas to determine a prediction block for the current block. Leveraging block vectors to increase the search area may result a higher likelihood of identifying a prediction block that promotes efficient encoding or decoding, without substantial increase in processing complexity or processing time.

In one example, the disclosure describes a method of decoding video data, the method comprising: determining a predefined search area that is predefined based on dimensions of a current block within a current picture; determining one or more block vectors; determining one or more additional search areas based on the one or more block vectors; determining a prediction block for the current block based on the predefined search area and the one or more additional search areas; and reconstructing the current block based on the prediction block.

In one example, the disclosure describes a device for decoding video data, the device comprising: one or more memories configured to store the video data; and processing circuitry coupled to the one or more memories, wherein the processing circuitry is configured to: determine a predefined search area that is predefined based on dimensions of a current block within a current picture; determine one or more block vectors; determine one or more additional search areas based on the one or more block vectors; determine a prediction block for the current block based on the predefined search area and the one or more additional search areas; and reconstruct the current block based on the prediction block.

In one example, the disclosure describes a device for encoding video data, the device comprising: one or more memories configured to store the video data; and processing circuitry coupled to the one or more memories, wherein the processing circuitry is configured to: determine a predefined search area that is predefined based on dimensions of a current block within a current picture; determine one or more block vectors; determine one or more additional search areas based on the one or more block vectors; determine a prediction block for the current block based on the predefined search area and the one or more additional search areas; and encode the current block based on the prediction block.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a block diagram illustrating an example video encoder that may perform the techniques of this disclosure.

FIG. 3 is a block diagram illustrating an example video decoder that may perform the techniques of this disclosure.

FIG. 4 is a flowchart illustrating an example method for encoding a current block in accordance with the techniques of this disclosure.

FIG. 5 is a flowchart illustrating an example method for decoding a current block in accordance with the techniques of this disclosure.

FIG. 6 is a conceptual diagram illustrating an example of an intra template matching search area.

FIG. 7 is a conceptual diagram illustrating template matching on a search area around an initial motion vector.

FIG. 8 is a conceptual diagram illustrating an example of a template and reference samples of the template in reference pictures.

FIG. 9 is a conceptual diagram illustrating an example of a template and reference samples of the template for block with sub-block motion using motion information of sub-blocks of current block.

FIGS. 10A-10D are conceptual diagrams illustrating examples of intra-block copy (IBC) reference regions depending on current coding unit (CU) position.

FIG. 11A is a conceptual diagram illustrating axis regions placed outside a search range.

FIG. 11B is a conceptual diagram illustrating axis regions placed partially in a search range.

FIG. 12A is a conceptual diagram illustrating an example of rectangular block vector area around a merge candidate.

FIG. 12B is a conceptual diagram illustrating an example of a cross-shaped block vector area around a merge candidate.

FIG. 13 is a conceptual diagram illustrating an example division of a cross-shaped block vector search area into center and lobes.

FIG. 14 is a conceptual diagram illustrating an example of a regions for subsampled sum of absolute differences (SAD) computation.

FIG. 15 is a flowchart illustrating an example method of operation.

### DETAILED DESCRIPTION

This disclosure is related to defining different methods (e.g., template type, fusion) using in the template matching TM related tools. The disclosed methods can be applied to any of the existing video codecs, such as HEVC (High Efficiency Video Coding), VVC (Versatile Video Coding), Essential Video Coding (EVC) or be an efficient coding tool in future video coding standards (e.g., ECM (Enhanced Compression Model)).

Template matching is a video coding tool that allows a video coder (e.g., video encoder or video decoder) to determine a prediction block that is a better predictor of the current block as compared to a prediction block determined without template matching. There may be other example usages of template matching, and using template matching for determining a prediction block is one example. For inter-prediction, where template matching is used, the prediction block may be based on samples in another picture. For intra-prediction or intra-block copy (IBC), where template matching is used, the prediction block may be based on samples in the same picture.

In template matching, a video coder determines a search range (e.g., search area), and determines templates (e.g., reference templates) within the search area. For instance, the video coder may utilize an initial motion vector or block vector to identify a location in a picture (e.g., reference picture for motion vector and same picture for block vector). For template matching in intra-prediction (e.g., IntraTM), there may not be a vector used to identify a location in the picture, and other techniques may be used to identify the location.

The video coder may determine a search area relative to the identified location. In one example, the reference template may be samples, within the search area, proximate to a reference block (e.g., identified by the initial motion vector or block vector or identified using other techniques). The video coder may determine a current template (e.g., based on samples proximate to a current block). The video coder may determine a cost based on the reference template and the current template. The video coder may then modify the initial vector or block vector or identify another location, and repeat the process of determining reference templates and respective costs. The video coder may set the motion vector based on the reference templates that resulted in the lowest cost. The video coder may then determine a prediction block for the current block based on the motion vector. For intra-prediction, the video coder may determine a prediction block without need of a motion vector or block vector.

This disclosure describes examples of extending the search range (e.g., search area) to incorporate additional area. By extending the search area, it may be possible for the video coder to identify a better prediction block (e.g., one that is a predictor for the current block) as compared to techniques that limit the size of the search area. However, increasing the size of the search area may increase the number of computations (e.g., increase number of reference templates that are generated and increase number of cost calculations). In one or more examples, the disclosure describes example techniques to increase the search area and example ways in which to determine cost in a manner that balances computational complexity with coding gains achieved from determining a better motion vector or block vector (e.g., where the motion vector or block vector identify samples for generating a better prediction block).

Although template matching is described as a way to refine a motion vector or block vector such as for determining a prediction block or being used as part of intra-prediction, the example techniques are not so limited. In general, the example techniques may be utilized in various video coding tools that utilize template matching (TM), such as intra template matching (IntraTM), inter template matching (InterTM), adaptive reordering of merge candidates with template matching (ARMC-TM), geometric partition mode template matching (GPM-TM), and intra-block copy template matching (IBC-TM), as a few examples.

As described in more detail, in some examples, the video coder may be configured to determine a search area for template matching based on at least one of a width or height of a current block. In some examples, the video coder may be configured to determine a search area for template matching, the search area extending at least one of vertically or horizontally from a current block to a respective search axis. In some examples, the video coder may be configured to determine a search area for template matching based on one or more block vectors for one or more blocks proximate to a current block.

In some examples, the video coder may be configured to determine a cost of the template (e.g., reference template) based on a portion of the template that is less than the entire template. In some examples, the video coder may be configured to determine a cost based on at least one of a filtered reference template (e.g., reference template that is filtered) and a filtered current template (e.g., current template that is filtered). In some examples, the video coder may be configured to determine a cost based on a first part of a reference template and a first part of a current template, and based on the cost being greater than a threshold value, discard the first reference template for determining a prediction block for the current block.

In some examples, the video coder may utilize a combination of the above example techniques for determining a search area (e.g., the techniques for determining the search area may be combined as practical or different parts of the techniques may be combined as practical). In some examples, the video coder may utilize a combination of the above example techniques for determining a cost (e.g., the techniques for determining the cost may be combined as practical or different parts of the techniques may be combined as practical). Also, the example techniques of determining the search areas and the example techniques of determining the costs may be combined (e.g., one or combination of the techniques may be used for determining the search area, and one or combination of technique may be used for determining the cost).

As described above, the video coder may extend the search area. For instance, there may be a predefined search area that is predefined based on dimensions of a current block within a current picture. The video coder may determine one or more additional search areas (e.g., in addition to the predefined search area) based on one or more block vectors. Examples of the block vectors may be block vectors of neighboring blocks. Determining a prediction block only within the predefined search area may not result in determining the best available prediction block, as the best available prediction block may be in a different area. Leveraging block vectors to expand the search area (e.g., determining additional search areas based on the block vectors) may result in determining a better prediction block than relying only on the predefined search area. Also, because the additional search areas are based on the block vectors, the size of the search area may be sufficiently small to negligibly increase processing delay.

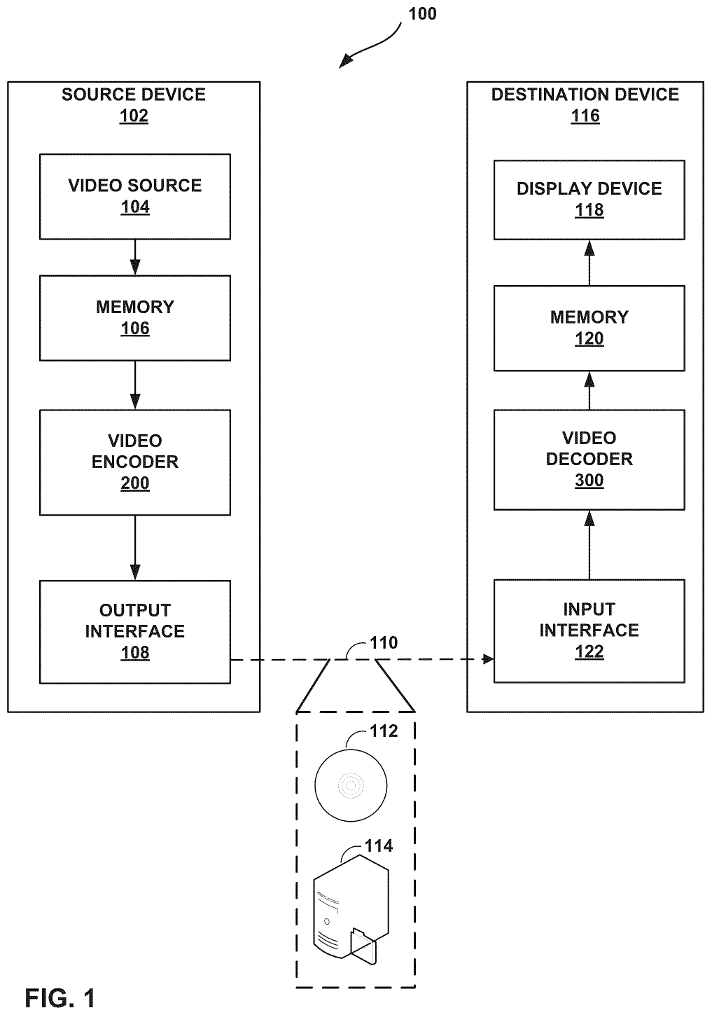

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be or include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for template matching. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for template matching. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder (e.g., audio codec), and may include appropriate MUX-DEMUX units, or other hardware and/or software, to handle multiplexed streams including both audio and video in a common data stream. Example audio codecs may include AAC, AC-3, AC-4, ALAC, ALS, AMBE, AMR, AMR-WB (G.722.2), AMR-WB+, aptx (various versions), ATRAC, BroadVoice (BV16, BV32), CELT, Enhanced AC-3 (E-AC-3), EVS, FLAC, G.711, G.722, G.722.1, G.722.2 (AMR-WB). G.723.1, G.726, G.728, G.729, G.729.1, GSM-FR, HE-AAC, ILBC, iSAC, LA Lyra, Monkey's Audio, MP1, MP2 (MPEG-1, 2 Audio Layer II), MP3, Musepack, Nellymoser Asao, OptimFROG, Opus, Sac, Satin, SBC, SILK, Siren 7, Speex, SVOPC, True Audio (TTA), TwinVQ, USAC, Vorbis (Ogg), WavPack, and Windows Media Aud.

Video encoder 200 and video decoder 300 each may be implemented as any of a variety of suitable encoder and/or decoder circuitry that includes a processing system, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may implement video encoder 200 and/or video decoder 300 in processing circuitry such as an integrated circuit and/or a microprocessor. Such a device may be a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that use template matching. For example, video encoder 200 and video decoder 300 may be configured to determine a search area and/or determine cost associated with templates (e.g., reference templates) using the example techniques described in this disclosure.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

As described above, video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multi-view Video Coding (MVC) extensions.

In addition, High Efficiency Video Coding (HEVC) or ITU-T H.265, including its range extension, multiview extension (MV-HEVC) and scalable extension (SHVC), has been developed by the Joint Collaboration Team on Video Coding (JCT-VC) as well as Joint Collaboration Team on 3D Video Coding Extension Development (JCT-3V) of ITU-T Video Coding Experts Group (VCEG) and ISO/IEC Motion Picture Experts Group (MPEG). The latest HEVC draft specification, and referred to as HEVC WD hereinafter, is available from http://phenix.int-evry.fr/jct/doc_end_user/documents/14_Vienna/wg11/JCTVC-N1003-v1.zip

ITU-T VCEG (Q6/16) and ISO/IEC MPEG (JTC 1/SC 29/WG 11) studied the potential need for standardization of future video coding technology with a compression capability that significantly exceeds that of the current HEVC standard (including its current extensions and near-term extensions for screen content coding and high-dynamic-range coding). The groups worked together on this exploration activity in a joint collaboration effort known as the Joint Video Exploration Team (JVET) to evaluate compression technology designs proposed by their experts in this area. The latest version of reference software, i.e., VVC Test Model 10 (VTM 10) could be downloaded from: https://vcgit.hhi.fraunhofer.de/jvet/VVCSoftware_VTM

The Versatile Video Coding (VVC) draft specification could be referred to JVET-T2001. Algorithm description of Versatile Video Coding and Test Model 10 (VTM 10.0) could be referred to JVET-T2002.

The following describes intra template matching (IntraTM). Intra template matching prediction (also called Intra TMP) is a special intra prediction mode that copies the best prediction block from the reconstructed part of the current frame, whose L-shaped, Left or Above template matches the current template. For a predefined search range (e.g., search area), video encoder 200 searches for the most similar template to the current template in a reconstructed part of the current frame (picture) and uses the corresponding block as a prediction block. Video encoder 200 then signals the usage of this mode, and the same prediction operation is performed at the decoder side by video decoder 300.

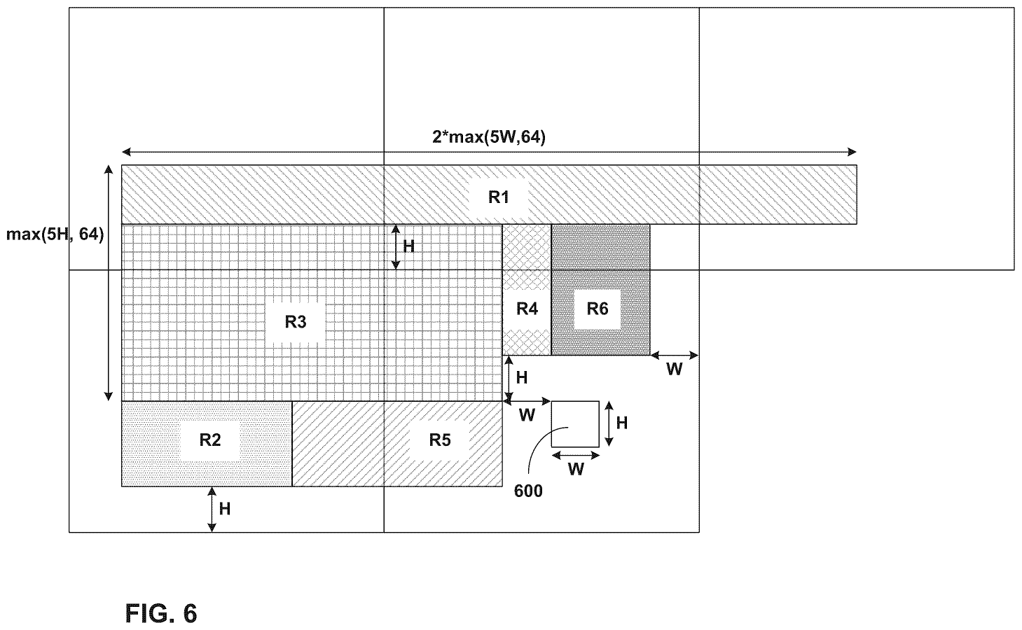

FIG. 6 is a conceptual diagram illustrating an example of an intra template matching search area. The prediction signal (e.g., prediction block) is generated by matching the L-shaped, Left or Above causal neighbor of the current block 600 with another block in a predefined search area in FIG. 6 consisting of: R1: above CTUs, R2: left CTUs below current block 600, R3: left CTUs above current block 600 plus top-left part of current CTU, R4: top part of current CTU, R5: bottom-left part of current CTU, and R6: top-right part of current CTU.

The L-shape template includes Left, Above and Above-left template parts, collectively referred to as reference templates. The cost function may be sum of absolute differences (SAD).

Within each region, video decoder 300 searches for the template that has least SAD with respect to the current one and uses its corresponding block as a prediction block. In such techniques, the dimensions of all regions (SearchRange_w, SearchRange_h) are set proportional to the block dimension (BlkW, BlkH) to have a fixed number of SAD comparisons per pixel. That is: SearchRange_w=max (a*BlkW, MinRange) and SearchRange_h=max (a*BlkH, MinRange), Where ‘a’ is a constant that controls the gain/complexity trade-off and MinRange is the minimal linear search area size. In practice, ‘a’ is equal to 5, MinRange=64.

Accordingly, FIG. 6 illustrates an example of a predefined search area that is predefined based on dimensions of a current block (e.g., current block 600). For instance, the dimensions (e.g., width (BlkW) and height (BlkH) of current block 600, and possibly the location of current block 600, may indicate where regions R1-R6 are located. However, the location of regions R1-R6 may be predefined based on the dimensions of the current block 600. For example, R1 is above the CTU, and the location of R1 is predefined relative to the dimensions of current block 600. The same may be for the other regions R2-R6.

The Intra template matching tool is enabled for CUs with size less than or equal to 64 in width and height. This maximum CU size for Intra template matching is configurable. The Intra template matching prediction mode is signaled at CU level through a dedicated flag when DIMD is not used for current CU.

The search region, also called search area, (R1 to R6 in FIG. 6) is sub-sampled by an integer factor 3, in some examples. This reduces the template matching search by a factor of 9. After finding the best match, multi-stage refinement process is performed in which another template matching search is performed around the best match with a reduced search range restricted to the zone from the set R1, R2, R3, R4, R5, R6 in which the best match was found at the first stage. The refined search range is fixed to be 1.

In one or more examples, determining a prediction signal (e.g., prediction block) based on a search with the predefined search area, such as the example illustrated in FIG. 6, may not necessarily result in the optimal prediction block, in terms of coding efficiency. That is, there may be another block, located outside the predefined search area that better approximates the current block 600 than blocks within the predefined search area.

However, searching the entirety of the picture that includes current block 600 for a block that better approximates current block 600 may increase processing delays. In or more examples, video encoder 200 and decoder 300 may be configured to determine one or more additional search areas (e.g., in addition to the predefined search area) based on one or more block vectors (e.g., vectors to point to samples in the same picture as current block 600). This way, video encoder 200 and video decoder 300 may not need to search the entirety of the current picture for a block that better approximates current block 600, but can define additional search areas where there is a higher likelihood of identifying a block that better approximates current block 600. For instance, the block vectors used to determine the additional search areas may be block vector predictors for the current block, such as block vectors of neighboring (e.g., proximate) blocks.

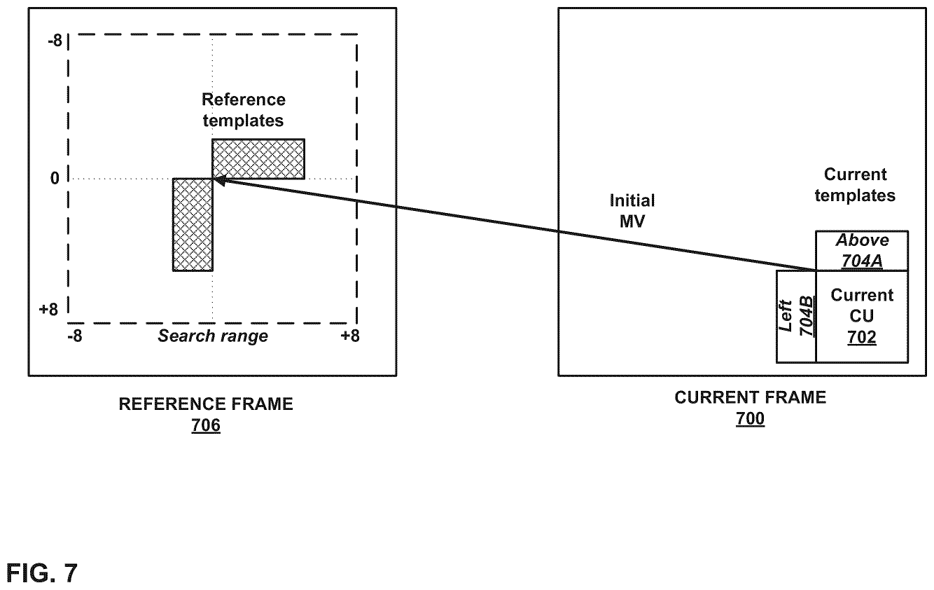

The following describes inter template matching. Inter template matching (InterTM) is a decoder-side MV derivation method to refine the motion information of the current CU 702 in current frame 700 (e.g., current picture 700) by finding the closest match between a template (i.e., top and/or left neighboring blocks of the current CU) in the current picture and a block (i.e., same size to the template) in a reference picture. For example, FIG. 7 illustrates current template 704 formed by above template 704A and left template 704B. FIG. 7 also illustrates reference template in reference frame 706 (e.g., reference picture 706).

As illustrated in FIG. 7, a better MV is searched around the initial motion of the current CU within a [−8, +8]-pel search range. The template matching method in JVET-J0021: “Description of SDR, HDR and 360° video coding technology proposal by Qualcomm and Technicolor-low and high complexity versions” is used with the following modifications: search step size is determined based on AMVR (advance motion vector resolution) mode and InterTM can be cascaded with bilateral matching process in merge modes.

In AMVP (advanced motion vector prediction) mode, an MVP (motion vector predictor) candidate is determined based on template matching error to select the one which reaches the minimum difference between the current block template (e.g., current template 704) and the reference block template (e.g., reference template in reference frame 706), and then InterTM is performed only for this particular MVP candidate for MV refinement. InterTM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 1. This search process ensures that the MVP candidate still keeps the same MV precision as indicated by the AMVR mode after TM process. In the search process, if the difference between the previous minimum cost and the current minimum cost in the iteration is less than a threshold that is equal to the area of the block, the search process terminates.

TABLE 1
Search patterns of AMVR and merge mode with AMVR.

| | AMVR mode | | | | Merge mode | |
|---|---|---|---|---|---|---|
| Search | 4- | Full- | Half- | Quarter- | AltIF = | AltIF = |
| pattern | pel | pel | pel | pel | 0 | 1 |
| 4-pel | v | | | | | |
| diamond | | | | | | |
| 4-pel cross | v | | | | | |
| Full-pel | | v | v | v | v | v |
| diamond | | | | | | |
| Full-pel | | v | v | v | v | v |
| cross | | | | | | |
| Half-pel | | | v | v | v | v |
| cross | | | | | | |
| Quarter-pel | | | | v | v | |
| cross | | | | | | |
| ⅛-pel cross | | | | | v | |

In merge mode, similar search method is applied to the merge candidate indicated by the merge index. As Table 1 shows, InterTM may perform all the way down to ⅛-pel MVD precision or skipping those beyond half-pel MVD precision, depending on whether the alternative interpolation filter (that is used when AMVR is of half-pel mode) is used according to merged motion information. When TM mode is enabled, template matching may work as an independent process or an extra MV refinement process between block-based and subblock-based bilateral matching (BM) methods, depending on whether BM can be enabled or not according to its enabling condition check.

The following describes adaptive reordering of merge candidates with template matching (ARMC-TM). The merge candidates are adaptively reordered with template matching TM. The reordering method is applied to regular merge mode, TM merge mode, and affine merge mode (excluding the SbTMVP candidate). For the TM merge mode, merge candidates are reordered before the refinement process.

An initial merge candidate list is firstly constructed according to given checking order, such as spatial, TMVPs (temporal motion vector predictors), non-adjacent, HMVPs (history-based motion vector predictors), pairwise, and virtual merge candidates. Then the candidates in the initial list are divided into several subgroups. For the template matching TM merge mode, adaptive DMVR (decoder-side motion vector refinement) mode, each merge candidate in the initial list is firstly refined by using TM/multi-pass DMVR. Merge candidates in each subgroup are reordered to generate a reordered merge candidate list and the reordering is according to cost values based on template matching. The index of selected merge candidate in the reordered merge candidate list is signaled to video decoder 300. For simplification, merge candidates in the last but not the first subgroup are not reordered. All the zero candidates from the ARMC reordering process are excluded during the construction of Merge motion vector candidates list. The subgroup size is set to 5 for regular merge mode and TM merge mode. The subgroup size is set to 3 for affine merge mode.

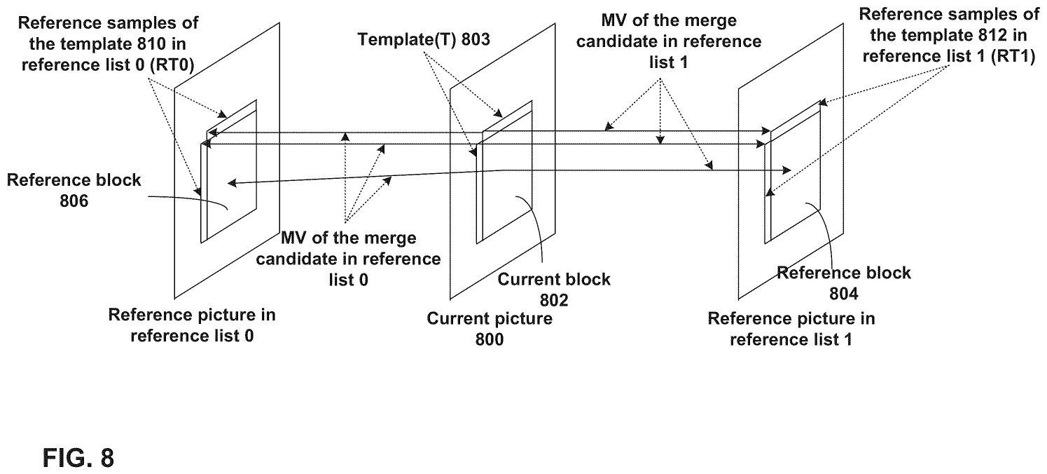

For cost calculation, the template matching cost values of a merge candidate during the reordering process is measured by the SAD between samples of a template of the current block and their corresponding reference samples. For example, FIG. 8 illustrates current block 802 in current picture 800 having current template 803, reference block 806 in a reference picture in reference list 0 having reference template 810, and reference block 804 in a reference picture in reference list 1 having reference template 812.

The template 803 comprises a set of reconstructed samples neighboring to the current block 802. Reference samples of the template 806 or 812 are located by the motion information of the merge candidate. When a merge candidate utilizes bi-directional prediction, the reference samples of the template 806 or 812 of the merge candidate are also generated by bi-prediction as shown in FIG. 8.

For refinement of the initial merge candidate list, when multi-pass DMVR is used to derive the refined motion to the initial merge candidate list only the first pass (i.e., PU level) of multi-pass DMVR is applied in reordering. When template matching is used to derive the refined motion, the template size is set equal to 1. Only the above or left template is used during the motion refinement of TM when the block is flat with block width greater than 2 times of height or narrow with height greater than 2 times of width. TM is extended to perform 1/16-pel MVD precision. The first four merge candidates are reordered with the refined motion in TM merge mode.

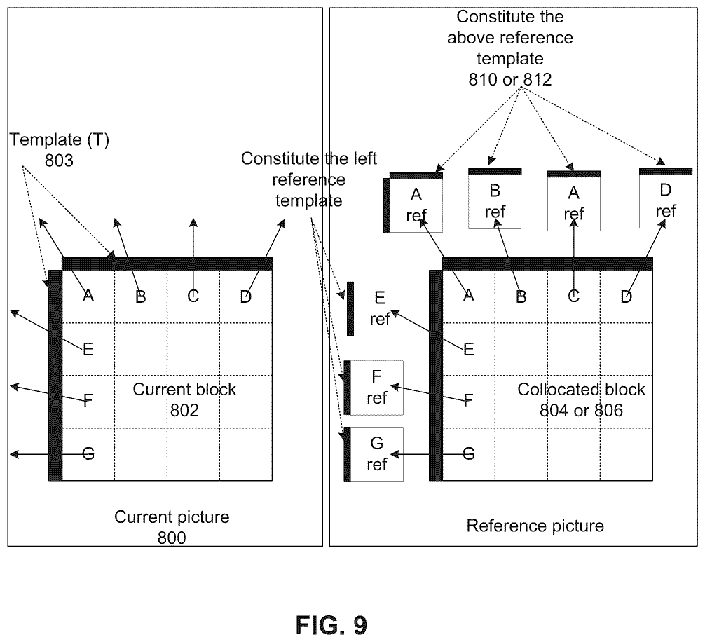

For subblock-based merge candidates with subblock size equal to Wsub×Hsub, the above template comprises several sub-templates with the size of Wsub×1, and the left template comprises several sub-templates with the size of 1×Hsub. As shown in FIG. 9, the motion information of the subblocks in the first row and the first column of current block 802 is used to derive the reference samples of each sub-template.

In the reordering process, a candidate is considered as redundant if the cost difference between a candidate and its predecessor is inferior to a lambda value e.g. |D1−D2|<λ, where D1 and D2 are the costs obtained during the first ARMC ordering and 2 is the Lagrangian parameter used in the RD criterion at encoder side.

An algorithm is defined as the following. Determine the minimum cost difference between a candidate and its predecessor among all candidates in the list. If the minimum cost difference is superior or equal to 2, the list is considered diverse enough and the reordering stops. If this minimum cost difference is inferior to 2, the candidate is considered as redundant, and it is moved at a further position in the list. This further position is the first position where the candidate is diverse enough compared to its predecessor. The algorithm stops after a finite number of iterations (if the minimum cost difference is not inferior to λ).

This algorithm is applied to the Regular, TM, BM and Affine merge modes. A similar algorithm is applied to the Merge MMVD and sign MVD prediction methods which also use ARMC for the reordering.

The value of λ is set equal to the λ of the rate distortion criterion used to select the best merge candidate at the encoder side by video encoder 200 for low delay configuration and to the value λ corresponding to another QP (quantization parameter) for Random Access configuration. A set of λ values corresponding to each signaled QP offset is provided in the SPS (sequence parameter set) or in the Slice Header for the QP offsets which are not present in the SPS.

For extension to AMVP modes, the ARMC design is also applicable to the AMVP mode, where the AMVP candidates are reordered according to the TM cost value. For the template matching for advanced motion vector prediction (TM-AMVP) mode, an initial AMVP candidate list is constructed, followed by a refinement from TM to construct a refined AMVP candidate list. In addition, an MVP candidate with a TM cost value larger than a threshold, which is equal to five times of the cost of the first MVP candidate, is skipped. In some examples, when wrap around motion compensation is enabled, the MV candidate may be clipped with wrap around offset taken into consideration.

The following describes geometric partitioning mode (GPM) with template matching TM. Template matching is applied to GPM. When GPM mode is enabled for a CU, a CU-level flag is signaled to indicate whether TM is applied to both geometric partitions. Motion information for each geometric partition is refined using TM. When TM is chosen, a template is constructed using left, above or left and above neighboring samples according to partition angle, as shown in Table 2. The motion is then refined by minimizing the difference between the current template and the template in the reference picture using the same search pattern of merge mode with half-pel interpolation filter disabled.

TABLE 2
Template for the 1st and 2nd geometric partitions, where A represents using above samples,
L represents using left samples, and L + A represents using both left and above samples.

| Partition angle | 0 | 2 | 3 | 4 | 5 | 8 | 11 | 12 | 13 | 14 |
|---|---|---|---|---|---|---|---|---|---|---|
| 1st partition | A | A | A | A | L + A | L + A | L + A | L + A | A | A |
| 2nd partition | L + A | L + A | L + A | L | L | L | L | L + A | L + A | L + A |
| Partition angle | 16 | 18 | 19 | 20 | 21 | 24 | 27 | 28 | 29 | 30 |
| 1st partition | A | A | A | A | L + A | L + A | L + A | L + A | A | A |
| 2nd partition | L + A | L + A | L + A | L | L | L | L | L + A | L + A | L + A |

A GPM candidate list is constructed as follows: Interleaved List-0 MV candidates and List-1 MV candidates are derived directly from the regular merge candidate list, where List-0 MV candidates are higher priority than List-1 MV candidates. A pruning method with an adaptive threshold based on the current CU size is applied to remove redundant MV candidates. Interleaved List-1 MV candidates and List-0 MV candidates are further derived directly from the regular merge candidate list, where List-1 MV candidates are higher priority than List-0 MV candidates. The same pruning method with the adaptive threshold is also applied to remove redundant MV candidates. Zero MV candidates are padded until the GPM candidate list is full.

The GPM-MMVD and GPM-TM may be exclusively enabled to one GPM CU. This is done by firstly signaling the GPM-MMVD syntax. When both two GPM-MMVD control flags are equal to false (i.e., the GPM-MMVD are disabled for two GPM partitions), the GPM-TM flag is signaled to indicate whether the template matching is applied to the two GPM partitions. Otherwise (at least one GPM-MMVD flag is equal to true), the value of the GPM-TM flag is inferred to be false.

The following describes intra-block copy (IBC) with template matching. Template Matching is used in IBC for both IBC merge mode and IBC AMVP mode.

The IBC-TM merge list is modified compared to the one used by regular IBC merge mode such that the candidates are selected according to a pruning method with a motion distance between the candidates as in the regular TM merge mode. The ending zero motion fulfillment is replaced by motion vectors to the left (−W, 0), top (0, −H) and top-left (−W, −H), where W is the width and H the height of the current CU.

In the IBC-TM merge mode, the selected candidates are refined with the Template Matching method prior to the RDO (rate-distortion optimization) or decoding process. The IBC-TM merge mode has been put in competition with the regular IBC merge mode and a TM-merge flag is signaled.

In the IBC-TM AMVP mode, up to 3 candidates are selected from the IBC-TM merge list. Each of those 3 selected candidates are refined using the Template Matching method and sorted according to their resulting Template Matching cost values. Only the 2 first ones are then considered in the motion estimation process as usual.

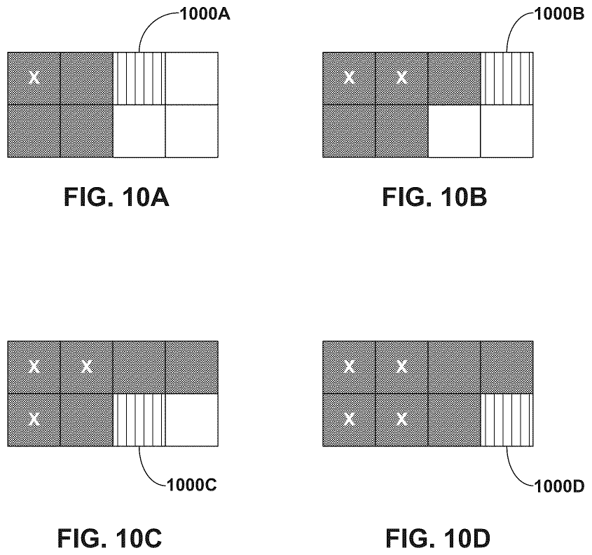

The Template Matching refinement for both IBC-TM merge and AMVP modes is based on IBC motion vectors being constrained (i) to be integer and (ii) within a reference region as shown in FIGS. 10A-10D. FIGS. 10A-10D illustrate location of current blocks 1000A-1000D. In IBC-TM merge mode, all refinements may be performed at integer precision, and in IBC-TM AMVP mode, refinements may be performed either at integer or 4-pel precision depending on the AMVR value. Such a refinement accesses only to samples without interpolation. In both cases, the refined motion vectors and the used template in each refinement step must respect the constraint of the reference region.

There may be certain problems with template matching techniques. The search range used for IntraTMP in ECM (further referred to as conventional search range or predefined search area) is a rectangle (excluding unavailable area) with dimensions proportional to the current block dimensions. Such design does not ensure optimal candidates capturing leaving many beneficial candidates beyond this range (e.g., area), while simple search range (e.g., area) extension increases computational complexity without reaching a good trade-off with compression rate. Furthermore, current ECM design enables narrow and long search ranges, e.g., having half-sizes 64×160 (for block size 8×32). Such design ignores a part of rather close and efficient candidates, while a distant search range part does not provide such many optimal candidates. Since any changes leading to search range extension, increase the number of TM cost value calculations, a simplification for the calculations may be beneficial to compensate the increasing complexity.

In this disclosure, various techniques are described to define an improved search range for TM-based tools within a frame (e.g., picture). The elements of the described techniques may be used independently or in any combination. Also, offset, unless specially indicated, designates below an offset from the current block to the reference block. For example, a reference block having top-left coordinate (4; 4) has offset (−4; −8) relatively to the current block having top-left coordinate (8; 12).

The following describes search area (e.g., search range) improvements. For instance, techniques for changing the search area are disclosed. These techniques can be applied to any search involving a search area, e.g., IntraTMP, InterTM, ARMC-TM, GPM-TM, IBC-TM. The techniques disclosed in this disclosure are used on decoder side (e.g., by video decode 300), however, can be used on encoder side (e.g., by video encoder 200, such as part of a reconstruction loop or otherwise).

For the search area size dependency, in ECM, the search area dimensions are derived from block dimensions: SearchRangeW=max(a·BlkW,MinSR), and SearchRangcH=max(a·BlkH,MinSR).

In one or more examples in accordance with techniques described in this disclosure, the search area dimensions may depend on both width and height of the current block. In one example, the search area is square-shaped and its dimension is linear in a greater dimension of the block
SearchRangeW=SearchRangeH=a·max(BlkW,BlkH). In another example, a restriction on the minimal size of the search area can be imposed:
SearchRangeW=SearchRangeH=max (a·max(BlkW,BlkH),MinSR). In another example, a restriction on the maximal size of the search area can be imposed:
SearchRangeW=SearchRangeH=min (a·max(BlkW,BlkH),MaxSR). In another example, minimal and maximal restrictions can be combined.

Accordingly, in one or more examples, a video coder (e.g., video encoder 200 or video decoder 300) may be configured to determine a search area for template matching based on at least one of a width or height of a current block, determine a prediction block based on the search area, and code (e.g., encode or decode) the current block based on the prediction block.

Stated another way, in one or more examples, video encoder 200 and video decoder 300 may determine a predefined search area that is predefined based on dimensions of a current block within a current picture. In some examples, a prediction block for the current block may be within this predefined search area, and video encoder 200 and video decoder 300 may determine this prediction block based on template matching techniques within the predefined search area. However, in accordance with one or more examples described in this disclosure, video encoder 200 and video decoder 300 may determine additional search areas based on block vectors, and determine a prediction block based on the predefined search area and the one or more additional search areas. That is, video encoder 200 and video decoder 300 may perform template matching techniques (e.g., determine template matching cost values) for blocks within the predefined search area and the one or more additional search areas.

For the axis search areas, in ECM, all available candidates in rectangular range having horizontal offsets in range [−SearchRangeW; +SearchRangeW] and vertical offsets in range [−SearchRangeH; +SearchRangeH] are considered, while no candidate having horizontal offset less than-SearchRangeW of vertical offset less than-SearchRangeH is considered. Given a block with top-left position (X, Y), the rectangular search area has a top-left position of (X−SearchRangeW, Y−SearchRangeH), a bottom-left position of (X−SearchRangeW, Y+SearchRangeH) and a top-right position of (X+SearchRangeW, Y−SearchRangeH).

In one or more examples in accordance with techniques described in this disclosure, the left border of the rectangular search range described above may be enlarged from −SearchRangeW to −SearchRangeAxisW, where SearchRangeAxisW is larger than SearchRangeW.

Similarly, the top border of the rectangular search range described above may be enlarged from −SearchRangeH to −SearchRangeAxisH, where SearchRangeAxisH is larger than SearchRangeH.

In one example, the search area in horizontal direction of range [−SearchRangeAxisW, −SearchRangeW−1] may be partly skipped from the search, excluding certain parts. For example, video encoder 200 and video decoder 300 may search within the search area except a part including blocks with vertical offset limited to a threshold T_H by absolute value. In one example, the search area in vertical direction of range [−SearchRangeAxisH, −SearchRangeH−1] is partly skipped, except a part including blocks with horizontal offset limited to a threshold T_W by absolute value. In one example, T_W and T_H may be smaller numbers compared to SearchRangeAxisW and SearchRangeAxisH, correspondingly.

In another example, the rectangular search range described above may be extended by two rectangles: Blocks having absolute value of vertical offset not exceeding threshold T_H and absolute horizontal offset is in a range [−SearchRangeAxisW; −SearchRangeW−1]. Blocks having absolute value of horizontal offset not exceeding threshold T_W and absolute vertical offset is in range [−SearchRangeAxisH; −SearchRangeH−1].

In one example, the horizontal axis zone locates center at a vertical position of XXX. The search area of horizontal axis zone is then defined to top-left position at (−SearchRangeAxisW, XXX−H), and bottom right position at (−SearchRangeW−1, XXX+H). Wherein H*2 is the height of the horizontal axis zone. Where in XXX is in a range of [Y−SearchRangeH+H, Y+SearchRangeH−H]. In one example, XXX is equal to 0.

In one example, the vertical axis zone locates center at a horizontal position of YYY. The search area of vertical axis zone is then defined to top-left position at (YYY−W, −SearchRangeAxisH), and bottom right position at (YYY+W, −SearchRangeH−1). Wherein W*2 is the width of the vertical axis zone. Where in YYY is in a range of [X−SearchRangeW+W, X+SearchRangeW−W]. In one example, YYY is equal to 0.

In one example, T_W and T_H are smaller than SearchRangeAxisW and SearchRangeAxisH correspondingly. In one example, T_W and T_H are set equal to some constant T. In another example, T_W and T_H are chosen proportional to block width and height correspondingly. In another example, T_W and T_H are additionally restricted to be not less than a value T_min and/or not larger than a value T_max.

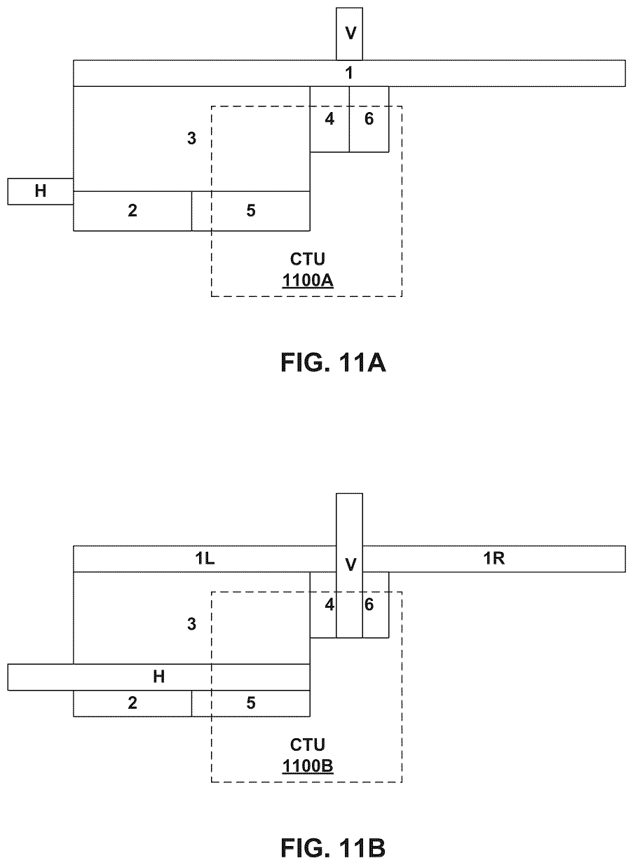

In one example, the extension may be implemented by adding two zones (referred to as axis zones) lying entirely beyond the rectangular search range described above and shown in FIG. 11B. For instance, FIG. 11A illustrates horizontal and vertical regions placed outside of the conventional range (zones 1-6) for CTU 1100A. FIG. 11B illustrates horizontal and vertical zones placed partly in the conventional range (zones 1-6) for CTU 1100B.

In another example, the added zones referred to as axis zones) may be defined to include a part of the rectangular search range, while division of this rectangular range into search regions should be adjusted accordingly to avoid region interception in this area (e.g., FIG. 11A). In this example, the search area of vertical axis zone is then defined to top-left position at (YYY−W, −SearchRangeAxisH), and bottom right position at (YYY+W, −BlkH). Wherein W*2 is the width of the vertical axis zone and SearchRangeAxisH is the height of the vertical axis zone. In this example, the search area of horizontal axis zone is then defined to top-left position at (−SearchRangeAxisW, XXX−H), and bottom right position at (−BlkW, XXX+H) Wherein SearchRangeAxisW is the width of the horizontal axis zone and H*2 is the height of the horizontal axis zone.

In one example, the axis zones are checked after regions of the rectangular search range. In another example, the axis zones are checked before one or several regions of the rectangular search range.

Accordingly, in one or more examples, a video coder (e.g., video encoder 200 or video decoder 300) may be configured to determine a search area for template matching, the search area extending at least one of vertically or horizontally from a current block to a respective search axis, determine a prediction block based on the search area, and code (e.g., encode or decode) the current block based on the prediction block. That is, FIGS. 11A and 11B illustrate examples of additional search areas, in addition to the predefined search areas, such as those of FIG. 6 that video encoder 200 and video decoder 300 may search to determine a prediction block for the current block using template matching techniques.

The above describes one example of determining one or more additional search areas that video encoder 200 and video decoder 300 may search to determine a prediction block. As described in more detail, in accordance with one or more examples described in this disclosure, video encoder 200 and video decoder 300 may determine one or more block vectors, and determine one or more additional search areas based on the one or more block vectors. The block vectors may be block vector predictors, such as block vectors of neighboring (e.g., proximate) blocks. The block vectors may identify samples in the same picture as the current picture.

For search areas around selected block vectors, to further extend a search area, video encoder 200 and video decoder 300 may select blocks vectors, and the search may be performed in a certain neighborhood around those block vectors. In one example, the selected blocks vectors may be block vector predictors of the current block, for example neighbor blocks block vectors or merge candidates block vectors.

For example, video encoder 200 and video decoder 300 may determine a predefined search area that is predefined based on dimensions of a current block within a current picture. One example of the predefined search area is regions R1-R6 illustrated in FIG. 6. Video encoder 200 and video decoder 300 may also determine one or more block vectors (e.g., block vector predictors of the current block from block vectors of neighboring blocks), and determine one or more additional search areas based on the one or more block vectors.

Video encoder 200 and video decoder 300 may determine a prediction block for the current block based on the predefined search area and the one or more additional search areas. As an example, video encoder 200 and video decoder 300 may determine template matching cost values between a current template of the current block and respective templates of prediction blocks in the predefined search area and the one or more additional search areas. For instance, video encoder 200 and video decoder 300 may start with a first prediction block within the predefined search area or the one or more additional search areas, and determine a template for the first prediction block (e.g., the template may be based on samples around the first reference block). Video encoder 200 and video decoder 300 may determine a first template matching cost value between the first reference block and the current block by comparing (e.g., determining SAD value performing or other techniques described in this disclosure) the template of the first reference block and the current template of the current block.

Video encoder 200 and video decoder 300 may repeat such operations for other prediction blocks in the predefined search area and the one or more additional search areas to determine a plurality of template matching cost values. In addition, in some examples, video encoder 200 and video decoder 300 may perform a refinement operation, where video encoder 200 and video decoder 300 determine additional prediction blocks based on the prediction blocks in the predefined search area and the one or more additional search areas. Video encoder 200 and video decoder 300 may determine template matching cost values for these additional prediction blocks as well. That is, the template matching cost values for the prediction blocks before refinement may be considered as first template matching cost values, and the template matching cost values for these additional prediction blocks may be referred to as second template matching cost values. Video encoder 200 and video decoder 300 may determine the prediction block for the current block based on the first template matching cost values and the second template matching cost values.

For example, video encoder 200 and video decoder 300 may determine the prediction blocks having the lowest template matching cost values. Video encoder 200 and video decoder 300 may determine additional prediction blocks based on proximate samples to the prediction block having the lowest template matching cost values.

Video encoder 200 and video decoder 300 may determine the prediction block based on the template matching cost values (e.g., the template matching cost values of the prediction blocks searched within the predefined search area and the one or more additional search areas). As one example, video encoder 200 and video decoder 300 may determine the prediction block as the prediction block associated with the lowest template matching cost value. As another example, video encoder 200 and video decoder 300 may construct a candidate list of prediction blocks arranged based on the respective template matching cost values (e.g., from lowest template matching cost value to highest template matching cost value). Video encoder 200 may signal and video decoder 300 may receive an index into the candidate list that identifies the prediction block.

The search area may be extended by one or several regions using a candidate as center positions and predefined-shape areas around them. A candidate can be derived from IBC merge list of the current block. One or several candidates can be used as center positions to define added search areas. That is, each candidate may be a block vector from the IBC merge list of the current block. A first block vector may point to a center location of a first additional search area, a second block vector may point to a center location of a second additional search area, and so forth. Accordingly, to determine the one or more additional search areas, video encoder 200 and video decoder 300 may determine respective center samples identified with each of the one or more block vectors, and determine respective predefined-shape areas around each of the respective center samples. As described in more detail, the predefined-shape areas may include one of a rectangular shape or a cross shape.

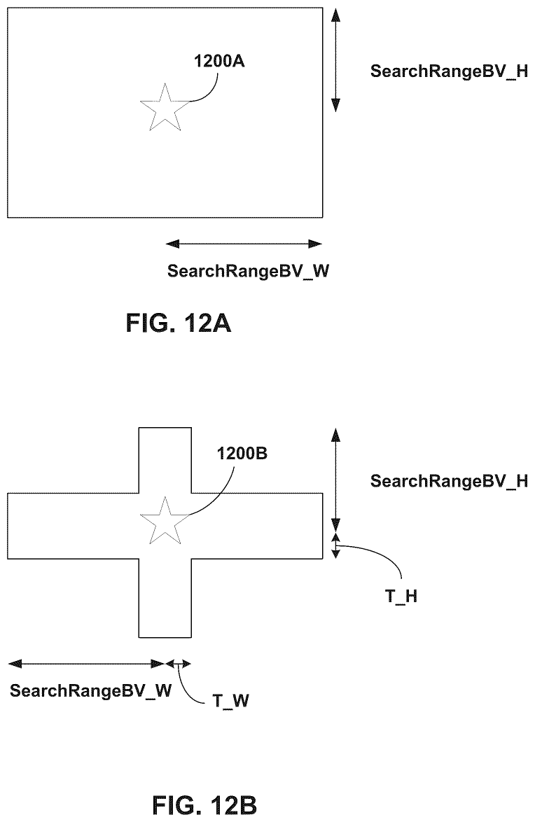

For instance, in one example, the added search areas may have a rectangular shape and include blocks having an absolute horizontal offset from center no more than SearchRangeBV_W and absolute vertical offset from the center no more than SearchRangeBV_H (FIG. 12A). For instance, FIG. 12A illustrates a rectangular block vector (BV) area around a merge candidate 1200A.

In another example, the added search areas may have a cross shape, being a part of a rectangle described in the previous example including blocks with either an absolute horizontal offset from the center not exceeding T_W or an absolute vertical offset from the center not exceeding T_H (FIG. 12B). For instance, FIG. 12B illustrates a cross-shaped block vector (BV) area around a merge candidate 1200B.

In one example, parameters SearchRangeBV_W, SearchRangeBV_H, T_W, T_H can be set constant. In another example, those parameters above may depend on block width and height. In another example, the added search areas are split into several subareas, one of which may be considered as the main one. First, the main subarea is checked. If no candidate obtained from this zone, all other subareas of the area are skipped. In one example, the whole area may be skipped if all candidates in the main subarea have TM cost value greater than a threshold. In one example, this threshold is set to the maximal TM cost value in the current candidate list.

As an example, one of the one or more additional search areas may include a main subarea and other subareas. To determine template matching cost values, video encoder 200 and video decoder 300 may determine template matching cost values between the current template and respective templates of prediction blocks in the main subarea. Based on none of the template matching cost values between the current template and respective templates of prediction blocks in the main subarea satisfying a threshold, video encoder 200 and video decoder 300 may determine template matching cost values between the current template and respective templates of prediction blocks in the other subareas. In this manner, the complexity and processing delays associated with checking the entirety of the additional search areas may be minimized.

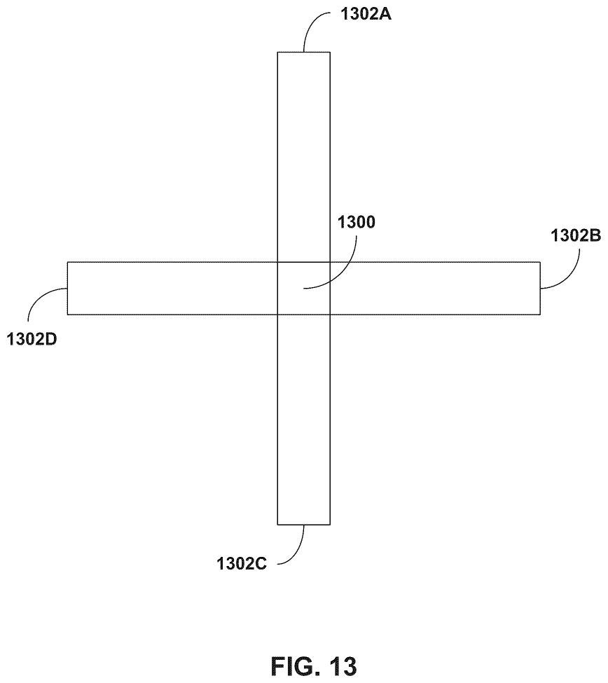

In one example, the cross-shaped added areas are split into a central squared region and 4 lobes (FIG. 13), wherein the central squared region is the main subarea. For instance, FIG. 13 illustrates center 1300 and lobes 1302A-1302D. In yet another example, a candidate in the current search area may be imposed to be excluded if the candidate is located at an overlap area of the current search area and one of the previous search area.

Accordingly, in one or more examples, a video coder (e.g., video encoder 200 or video decoder 300) may be configured to determine one or more block vectors for one or more blocks proximate to a current block, determine a search area for template matching based on the determined one or more block vectors, determine a prediction block based on the search area, and code (e.g., encode or decode) the current block based on the prediction block. The search area for template matching may be a search area in addition to the predefined search area that is predefined based on dimensions of the current block.

The following describes example techniques for optimizing of TM cost value calculation. The example techniques can be applied to any type of search involving template matching. Additionally, different TM cost value functions can be used on different stages of a multistage search.

For a subsampled TM cost value, to reduce the number of operations at TM cost value computation, only a part of a template may be used for the cost computation. Additionally, a multiplier factor equal to the ratio between the entire and used areas can be applied to the computed cost. In one example, only several lines of the template, which is used to derive the TM cost value, are chosen for the cost derivation, e.g. the template may be subsampled before the cost calculation. The cost derived from not the full template, for example where some samples or line of samples are excluded or template is subsampled, is called subsampled TM cost value, and full TM cost value is when it is derived using the full template. In another example, in each template line, only a part of the line is used for the cost computation.

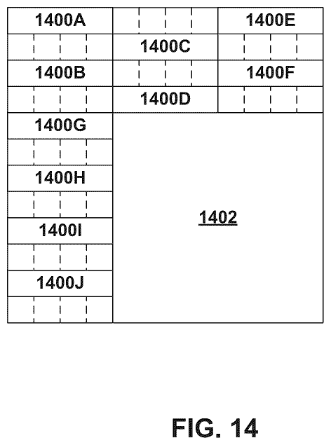

In another example, template parts used for TM cost value computation are chosen in a checkerboard pattern, interleaving used and unused regions in the template. FIG. 14 provides an example of such pattern. For instance, in FIG. 14 only regions 1400A-1400J may be used for TM cost value calculation, where regions 1400A-1400J are proximate block 1402 (e.g., current block or reference block). That is, regions 1400A-1400J may be at least one of regions of a current template or reference template.

In another example, subsampled TM cost value is used only at specific search stage(s). For example, subsampled TM cost value is used only for first stage. while other stages use a full TM cost value.

Accordingly, in one or more examples, a video coder (e.g., video encoder 200 or video decoder 300) may be configured to determine a template for template matching for coding a current block, determine a cost of the template based on a portion of the template that is less than the entire template (e.g., just for regions 1400), determine a prediction block for the current block based on the cost of the template, and code (e.g., encode or decode) the current block based on the prediction block.

For lowpass-filtered TM cost value (LP-TM cost value), a preliminary lowpass filtering operation is applied to the reference and current templates before TM cost value computation. In another example, filtering is applied to the reference and current templates after subtraction of reference sample value from a current sample value, but before extracting absolute values of the result. In one example, to reduce the number of availability checks while filtering, padding is applied unconditionally to all points beyond the template. In another example, the template is split into several blocks and filtering is carried out independently in each of these blocks and padding in applied unconditionally to all points lying beyond these blocks. In another embodiment, LP-TM cost value is used at specific search stage(s), for example, at the sparse search stage, while other stages use a non-filtered TM cost value.

Accordingly, in one or more examples, a video coder (e.g., video encoder 200 or video decoder 300) may be configured to filter at least one of a reference template and a current template for template matching for coding a current block to generate at least one of a filtered reference template or a filtered current template, determine a cost based on at least one of the filtered reference template and the filtered current template, determine a prediction block for the current block based on the cost, and code (e.g., encode or decode) the current block based on the prediction block.

For early TM cost value computation threshold, to reduce the number of operations in TM cost value computation, for example in TM-SAD computation, for candidates with a high TM cost value, the template may be split into several parts, which are processed independently from each other. In one example, the total TM cost value is the sum of costs for its parts. A threshold in defined for each of these parts. In one example, the cost computation may be terminated (and the candidate is then discarded) if the cost calculated in any part exceeds the threshold chosen for this part. In one example, individual thresholds for template parts are set to the current maximal TM cost value in the list, multiplied by a factor equal to area ratio of those template parts.

Accordingly, in one or more examples, a video coder (e.g., video encoder 200 or video decoder 300) may be configured to divide a first reference template and a current template into a plurality of parts comprising a first part for the reference template and a first part for the current template that are less than the entirety of the reference template and the current template, respectively, determine a cost based on the first part of the reference template and the first part of the current template, based on the cost being greater than a threshold value, discard the first reference template for determining a prediction block for the current block, determine the prediction block for the current block based on a second reference template, and code (e.g., encode or decode) the current block based on the prediction block.

As described above, the example techniques may be for video encoder 200 or video decoder 300. For instance, in the above examples, coding the current block may include decoding the current block. Video decoder 300 may be configured to receive residual information indicative of a difference between the current block and the prediction block, and add the residual information to the prediction block to generate the current block.

As another example, coding the current block may include decoding the current block as part of a reconstruction loop in a video encoding process. For instance, video encoder 200 may include a reconstruction loop in which video encoder 200 reconstructs the current block after encoding the current block. Video encoder 200 may perform the example techniques as part of that reconstruction loop. However, in some examples, video encoder 200 may perform the example techniques as part of encoding the current block.

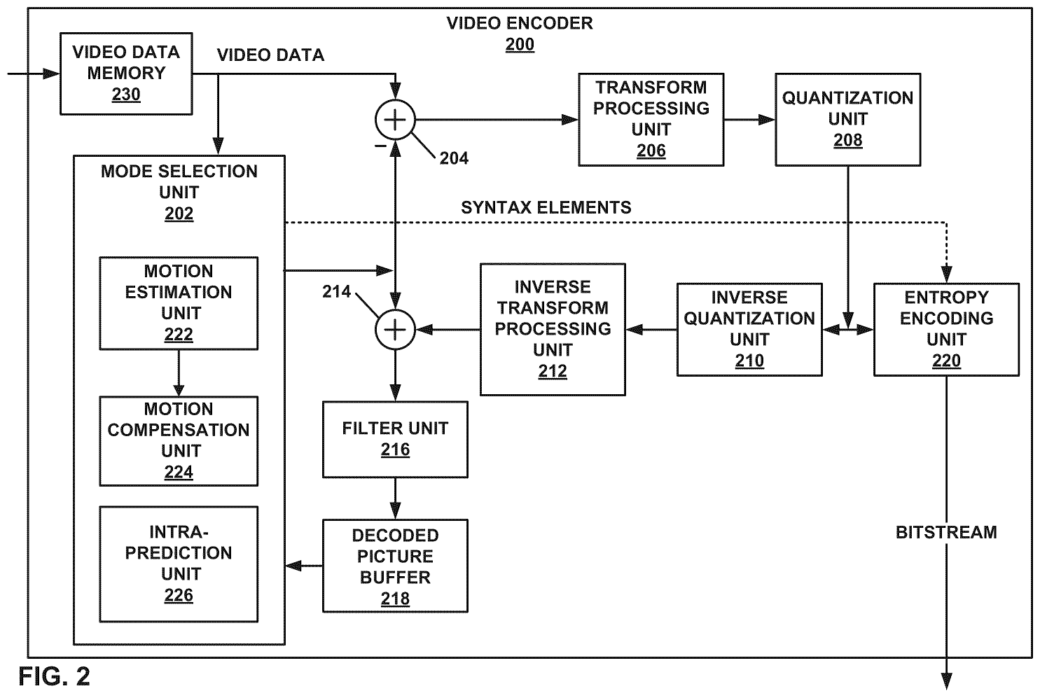

FIG. 2 is a block diagram illustrating an example video encoder 200 that may perform the techniques of this disclosure. FIG. 2 is provided for purposes of explanation and should not be considered limiting of the techniques as broadly exemplified and described in this disclosure. For purposes of explanation, this disclosure describes video encoder 200 according to the techniques of VVC and HEVC. However, the techniques of this disclosure may be performed by video encoding devices that are configured to other video coding standards and video coding formats, such as AV1 and successors to the AV1 video coding format.

In the example of FIG. 2, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 is an example of a memory system that may store video data to be encoded by the components of video encoder 200. Video encoder 200 may receive the video data stored in video data memory 230 from, for example, video source 104 (FIG. 1). DPB 218 is an example of a memory system that may act as a reference picture memory that stores reference video data for use in prediction of subsequent video data by video encoder 200. Video data memory 230 and DPB 218 may each be formed by any of a variety of one or more memory devices or memory units, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 2 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUS, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quadtree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra-prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 220 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to perform the example techniques described in this disclosure. For example, video encoder 200 may be configured to determine a search area for template matching based on at least one of a width or height of a current block, determine a search area for template matching, the search area extending at least one of vertically or horizontally from a current block to a respective search axis, or determine one or more block vectors for one or more blocks proximate to a current block, and determine a search area for template matching based on the determined one or more block vectors, or combination thereof.

As another example, video encoder 200 may be configured to determine a cost of the template based on a portion of the template that is less than the entire template, filter at least one of a reference template and a current template for template matching for coding a current block to generate at least one of a filtered reference template or a filtered current template, and determine a cost based on at least one of the filtered reference template and the filtered current template, or divide a first reference template and a current template into a plurality of parts comprising a first part for the reference template and a first part for the current template that are less than the entirety of the reference template and the current template, respectively, and determine a cost based on the first part of the reference template and the first part of the current template, or combination thereof.

As another example, video encoder 200 may determine a predefined search area that is predefined based on dimensions of a current block within a current picture, determine one or more block vectors, determine one or more additional search areas based on the one or more block vectors, determine a prediction block for the current block based on the predefined search area and the one or more additional search areas, and encode the current block based on the prediction block.

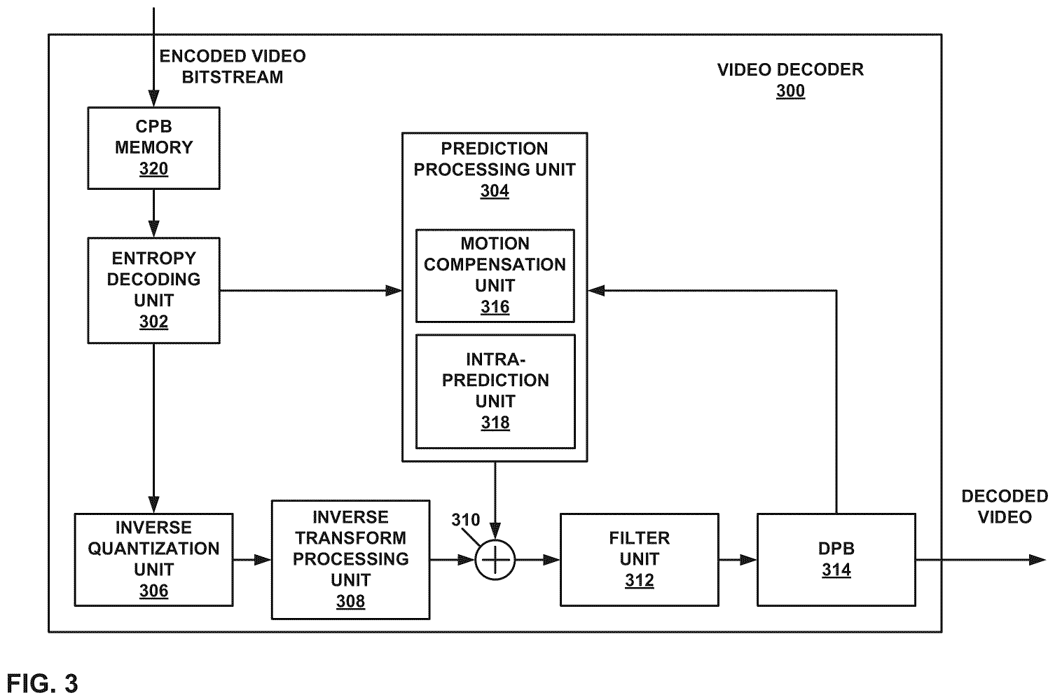

FIG. 3 is a block diagram illustrating an example video decoder 300 that may perform the techniques of this disclosure. FIG. 3 is provided for purposes of explanation and is not limiting on the techniques as broadly exemplified and described in this disclosure. For purposes of explanation, this disclosure describes video decoder 300 according to the techniques of VVC and HEVC. However, the techniques of this disclosure may be performed by video coding devices that are configured to other video coding standards.

In the example of FIG. 3, video decoder 300 includes coded picture buffer (CPB) memory 320, entropy decoding unit 302, prediction processing unit 304, inverse quantization unit 306, inverse transform processing unit 308, reconstruction unit 310, filter unit 312, and DPB 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra-prediction unit 318 may be configured to decode coding blocks of video data (e.g., both luma and chroma coding blocks) using directional intra prediction, non-directional intra prediction, recursive filter intra prediction, CFL, IBC, and/or color palette mode, as described above.

CPB memory 320 is an example of a memory system that may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 is an example of a memory system that generally stores decoded pictures, which video decoder 300 may output and/or use as reference video data when decoding subsequent data or pictures of the encoded video bitstream. CPB memory 320 and DPB 314 may each be formed by any of a variety of memory devices or memory units, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 3 are illustrated to assist with understanding the operations performed by video decoder 300. The units may be implemented as fixed-function circuits, programmable circuits, or a combination thereof. Similar to FIG. 2, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 2).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 2). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including a memory configured to store video data, and one or more processing units implemented in circuitry and configured to perform the example techniques described in this disclosure. For example, video decoder 300 may be configured to determine a search area for template matching based on at least one of a width or height of a current block, determine a search area for template matching, the search area extending at least one of vertically or horizontally from a current block to a respective search axis, or determine one or more block vectors for one or more blocks proximate to a current block, and determine a search area for template matching based on the determined one or more block vectors, or combination thereof.

As another example, video decoder 300 may be configured to determine a cost of the template based on a portion of the template that is less than the entire template, filter at least one of a reference template and a current template for template matching for coding a current block to generate at least one of a filtered reference template or a filtered current template, and determine a cost based on at least one of the filtered reference template and the filtered current template, or divide a first reference template and a current template into a plurality of parts comprising a first part for the reference template and a first part for the current template that are less than the entirety of the reference template and the current template, respectively, and determine a cost based on the first part of the reference template and the first part of the current template, or combination thereof.

As another example, video decoder 300 may determine a predefined search area that is predefined based on dimensions of a current block within a current picture, determine one or more block vectors, determine one or more additional search areas based on the one or more block vectors, determine a prediction block for the current block based on the predefined search area and the one or more additional search areas, and reconstruct the current block based on the prediction block.

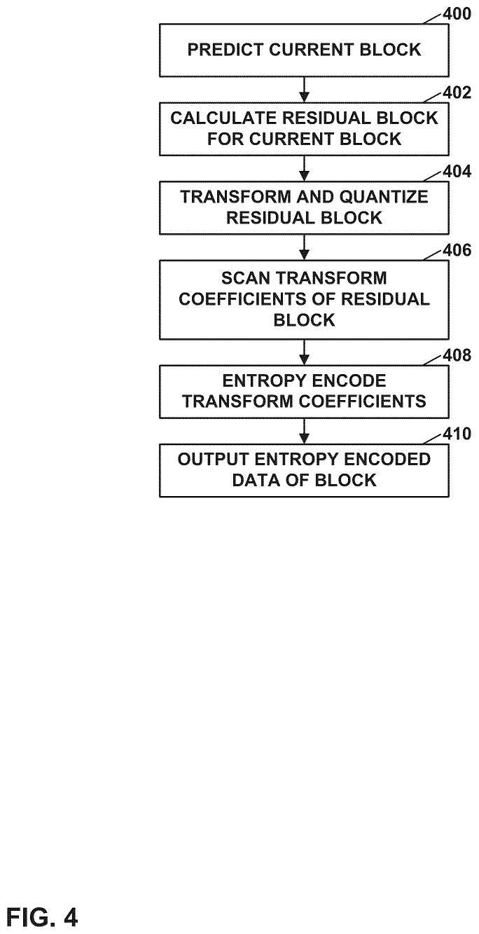

FIG. 4 is a flowchart illustrating an example method for encoding a current block in accordance with the techniques of this disclosure. The current block may be or include a current CU. Although described with respect to video encoder 200 (FIGS. 1 and 2), it should be understood that other devices may be configured to perform a method similar to that of FIG. 4.

In this example, video encoder 200 initially predicts the current block (400). For example, video encoder 200 may form a prediction block for the current block. Video encoder 200 may utilize the example techniques described in this disclosure to form the prediction block (e.g., prediction signal). Video encoder 200 may then calculate a residual block for the current block (402). To calculate the residual block, video encoder 200 may calculate a difference between the original, unencoded block and the prediction block for the current block. Video encoder 200 may then transform the residual block and quantize transform coefficients of the residual block (404). Next, video encoder 200 may scan the quantized transform coefficients of the residual block (406). During the scan, or following the scan, video encoder 200 may entropy encode the transform coefficients (408). For example, video encoder 200 may encode the transform coefficients using CAVLC or CABAC. Video encoder 200 may then output the entropy encoded data of the block (410).

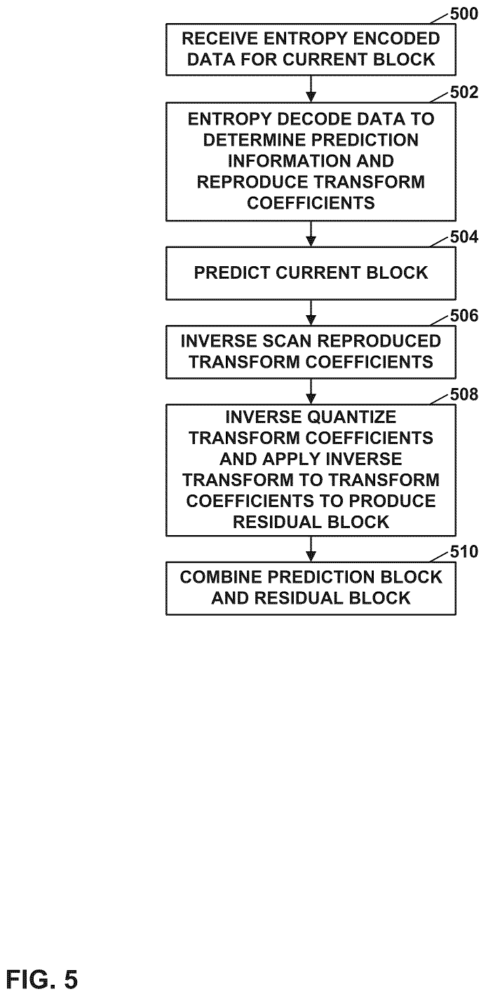

FIG. 5 is a flowchart illustrating an example method for decoding a current block of video data in accordance with the techniques of this disclosure. The current block may be or include a current CU. Although described with respect to video decoder 300 (FIGS. 1 and 3), it should be understood that other devices may be configured to perform a method similar to that of FIG. 5.

Video decoder 300 may receive entropy encoded data for the current block, such as entropy encoded prediction information and entropy encoded data for transform coefficients of a residual block corresponding to the current block (500). Video decoder 300 may entropy decode the entropy encoded data to determine prediction information for the current block and to reproduce transform coefficients of the residual block (502). Video decoder 300 may predict the current block (504), e.g., using an intra- or inter-prediction mode as indicated by the prediction information for the current block, to calculate a prediction block for the current block. Video decoder 300 may utilize the example techniques described in this disclosure to calculate the prediction block (e.g., prediction signal). Video decoder 300 may then inverse scan the reproduced transform coefficients (506), to create a block of quantized transform coefficients. Video decoder 300 may then inverse quantize the transform coefficients and apply an inverse transform to the transform coefficients to produce a residual block (508). Video decoder 300 may ultimately decode the current block by combining the prediction block and the residual block (510).

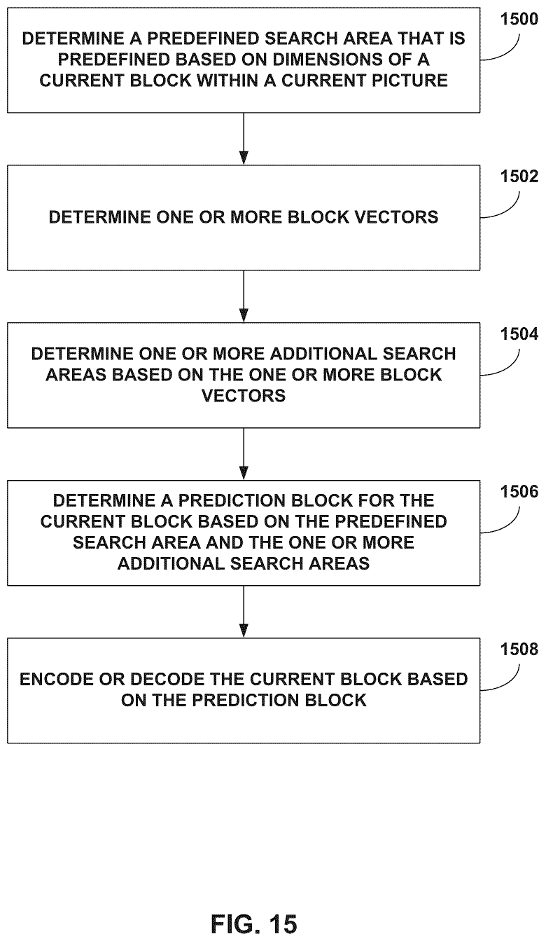

FIG. 15 is a flowchart illustrating an example method of operation. For case, the example techniques are described with respect to processing circuitry, examples of which include the processing circuitry of video encoder 200 or the processing circuitry of video decoder 300. For instance, one or more memories may be configured to store the video data. For processing circuitry of video encoder 200, examples of the one or more memories include memory 106, video data memory 230, decoded picture buffer 218, or some memory of video encoder 200. For processing circuitry of video decoder 300, examples of the one or more memories include memory 120, CPB memory 320, decoded picture buffer 314, or some memory of video decoder 300.

The processing circuitry may be configured to determine a predefined search area that is predefined based on dimensions of a current block within a current picture (1500). One example of the predefined search area is illustrated in FIG. 6 with regions R1-R6 as being examples of the predefined search area. As described above with respect to FIG. 6, the dimensions of all regions of the predefined search area (SearchRange_w, SearchRange_h) are set proportional to the block dimension (BlkW, BlkH) to have a fixed number of SAD comparisons per pixel. Another example of the predefined search area that is predefined based on dimensions of the current block is the example illustrated in FIGS. 11A and 11B.

The processing circuitry may be configured to determine one or more block vectors (1502). Examples of the one or more block vectors include block vector predictors for the current block, and wherein the one or more block vector predictors are based on block vectors of neighboring blocks. As an example, the one or more block vectors may be block vectors from an IBC merge list of the current block.

The processing circuitry may determine one or more additional search areas based on the one or more block vectors (1504). As an example, the processing circuitry may determine respective center samples identified with each of the one or more block vectors, and determine respective predefined-shape areas around each of the respective center samples. The predefined-shape areas comprise one of a rectangular shape or a cross shape.

As an example, the processing circuitry may determine a first center sample that is pointed to by a first block vector of the one or more block vectors. The processing circuitry may determine a predefined shape (e.g., rectangle or cross) around the first center sample. This predefined shape around first center sample may be the first additional search area. The processing circuitry may determine a second center sample that is pointed to by a second block vector of the one or more block vectors. The processing circuitry may determine a predefined shape (e.g., rectangle or cross) around the second center sample. This predefined shape around second center sample may be the second additional search area, and so forth.

The processing circuitry may determine a prediction block for the current block based on the predefined search area and the one or more additional search areas (1506). As one example, the processing circuitry may determine template matching cost values between a current template of the current block and respective templates of prediction blocks in the predefined search area and the one or more additional search areas.

For example, the processing circuitry may start with the predefined search area, and identify prediction blocks (e.g., candidate prediction blocks) within the predefined search area. The processing circuitry may compare the templates of each of the prediction blocks in the predefined search area to the current template of the current block to determine template matching cost values (e.g., SAD values or using techniques such as those of FIG. 14). The templates of the prediction blocks may be L-shaped, where the samples within the L-shape surrounding the prediction blocks form the template. The current template may be similar, but around the current block.

The processing circuitry may also identify prediction blocks (e.g., candidate prediction blocks) within the one or more additional search areas. The processing circuitry may compare the templates of each of the prediction blocks in the predefined search area to the current template of the current block to determine template matching cost values (e.g., SAD values or using techniques such as those of FIG. 14).

In some examples, the processing circuitry may perform further refinements, as part of a multi-stage process to determine the prediction block. For example, the template matching cost values for the prediction blocks in the predefined search area and the one or more additional search areas may be considered as first template matching cost values. The processing circuitry may determine additional prediction blocks based on the prediction blocks in the predefined search area and the one or more additional search areas. For instance, the processing circuitry may determine additional prediction blocks that are offset within an example rectangular area. As one example, the rectangular area have prediction blocks in the center. In some examples, the processing circuitry may determine additional prediction blocks that are offset one sample relative to prediction blocks having the lowest or lower than threshold template matching cost values, but the offset may be more than one sample and can be in a larger region. The processing circuitry may determine second template matching cost values between the current template and respective templates of the additional prediction blocks.

To determine the prediction block, the processing circuitry may determine the prediction block based on the template matching cost values. As one example, the processing circuitry may determine the prediction block for the current block based on the first template matching cost values and the second template matching cost values.

In some examples, the processing circuitry may determine the prediction block associated with the lowest template matching cost value. In some examples, the processing circuitry of video decoder 300 may construct a candidate list of prediction blocks arranged based on the respective template matching cost values (e.g., smallest to largest), and receive an index into the candidate list that identifies the prediction block.

In some examples, the processing circuitry may be configured to determine template matching cost values for only a portion of the one or more additional search areas. For example, one of the one or more additional search areas may include a main subarea and other subareas. To determine template matching cost values, the processing circuitry may determine template matching cost values between the current template and respective templates of prediction blocks in the main subarea, and based on none of the template matching cost values between the current template and respective templates of prediction blocks in the main subarea satisfying a threshold, determine template matching cost values between the current template and respective templates of prediction blocks in the other subareas.

The processing circuitry may encode or decode the current block based on the prediction block (1508). For example, to decode the current block, the processing circuitry of video decoder 300 may reconstruct the current block based on the prediction block. As example, the processing circuitry of video decoder 300 may receive residual information indicative of a difference between the current block and the prediction block, and add the residual information to the prediction block to reconstruct the current block. To encode the current block, the processing circuitry of video encoder 200 may determine residual information indicative of a difference between the current block and the prediction block, and signal the residual information.

The following numbered clauses illustrate one or more aspects of the devices and techniques described in this disclosure.

Clause 1A. A method of coding video data, the method comprising: determining a search area for template matching based on at least one of a width or height of a current block; determining a prediction block based on the search area; and coding the current block based on the prediction block.

Clause 2A. A method of coding video data, the method comprising: determining a search area for template matching, the search area extending at least one of vertically or horizontally from a current block to a respective search axis; determining a prediction block based on the search area; and coding the current block based on the prediction block.

Clause 3A. A method of coding video data, the method comprising: determining one or more block vectors for one or more blocks proximate to a current block; determining a search area for template matching based on the determined one or more block vectors; determining a prediction block based on the search area; and coding the current block based on the prediction block.

Clause 4A. A method of coding video data, the method comprising: determining a template for template matching for coding a current block; determining a cost of the template based on a portion of the template that is less than the entire template; determining a prediction block for the current block based on the cost of the template; and coding the current block based on the prediction block.

Clause 5A. A method of coding video data, the method comprising: filtering at least one of a reference template and a current template for template matching for coding a current block to generate at least one of a filtered reference template or a filtered current template; determining a cost based on at least one of the filtered reference template and the filtered current template; determining a prediction block for the current block based on the cost; and coding the current block based on the prediction block.

Clause 6A. A method of coding video data, the method comprising: dividing a first reference template and a current template into a plurality of parts comprising a first part for the reference template and a first part for the current template that are less than the entirety of the reference template and the current template, respectively; determining a cost based on the first part of the reference template and the first part of the current template; based on the cost being greater than a threshold value, discarding the first reference template for determining a prediction block for the current block; determining the prediction block for the current block based on a second reference template; and coding the current block based on the prediction block.

Clause 7A. The method of any of clauses 1A-6A, wherein coding the current block comprises decoding the current block, and wherein decoding the current block comprises: receiving residual information indicative of a difference between the current block and the prediction block; and adding the residual information to the prediction block to generate the current block.

Clause 8A. The method of any of clauses 1A-7A, wherein coding the current block comprises decoding the current block as part of a reconstruction loop in a video encoding process.

Clause 9A. The method of any of clauses 1A-6A, wherein coding the current block comprises encoding the current block.

Clause 10A. A method comprising a combination of features of any of claims 1A-9A.

Clause 11A. A device for coding video data, the device comprising: one or more memories configured to store the video data; and processing circuitry configured to perform the method of any of clauses 1A-10A.

Clause 12A. The device of clause 11A, further comprising a display configured to display decoded video data.

Clause 13A. The device of any of clauses 11A and 12A, wherein the device comprises one or more of a camera, a computer, a mobile device, a broadcast receiver device, or a set-top box.

Clause 14A. The device of any of clauses 11A-13A, wherein the device comprises a video decoder.

Clause 15A. The device of any of clauses 11A-14, wherein the device comprises a video encoder.

Clause 16A. A computer-readable storage medium having stored thereon instructions that, when executed, cause one or more processors to perform the method of any of clauses 1A-10A.

Clause 17A. A device for coding video data, the device comprising means for performing the method of any of clauses 1A-10A.

Clause 1. A method of decoding video data, the method comprising: determining a predefined search area that is predefined based on dimensions of a current block within a current picture; determining one or more block vectors; determining one or more additional search areas based on the one or more block vectors; determining a prediction block for the current block based on the predefined search area and the one or more additional search areas; and reconstructing the current block based on the prediction block.

Clause 2. The method of clause 1, further comprising: determining template matching cost values between a current template of the current block and respective templates of prediction blocks in the predefined search area and the one or more additional search areas, wherein determining the prediction block comprises determining the prediction block based on the template matching cost values.

Clause 3. The method of clause 2, wherein the template matching cost values are first template matching cost values, the method further comprising: determining additional prediction blocks based on the prediction blocks in the predefined search area and the one or more additional search areas; and determining second template matching cost values between the current template and respective templates of the additional prediction blocks, wherein determining the prediction block comprises determining the prediction block for the current block based on the first template matching cost values and the second template matching cost values.

Clause 4. The method of any of clauses 2 and 3, wherein one of the one or more additional search areas comprises a main subarea and other subareas, and
wherein determining template matching cost values comprises: determining template matching cost values between the current template and respective templates of prediction blocks in the main subarea; and based on none of the template matching cost values between the current template and respective templates of prediction blocks in the main subarea satisfying a threshold, determining template matching cost values between the current template and respective templates of prediction blocks in the other subareas.

Clause 5. The method of any of clauses 2-4, wherein determining the prediction block comprises determining the prediction block associated with the lowest template matching cost value.

Clause 6. The method of any of clauses 2-4, wherein determining the prediction block comprises: constructing a candidate list of prediction blocks arranged based on the respective template matching cost values; and receiving an index into the candidate list that identifies the prediction block.

Clause 7. The method of any of clauses 1-6, wherein the one or more block vectors comprise one or more block vector predictors for the current block, and wherein the one or more block vector predictors are based on block vectors of neighboring blocks.

Clause 8. The method of any of clauses 1-7, wherein determining the one or more additional search areas comprises: determining respective center samples identified with each of the one or more block vectors; and determining respective predefined-shape areas around each of the respective center samples.

Clause 9. The method of clause 8, wherein the predefined-shape areas comprise one of a rectangular shape or a cross shape.

Clause 10. The method of any of clauses 1-9, wherein reconstructing the current block comprises: receiving residual information indicative of a difference between the current block and the prediction block; and adding the residual information to the prediction block to reconstruct the current block.

Clause 11. A device for decoding video data, the device comprising: one or more memories configured to store the video data; and processing circuitry coupled to the one or more memories, wherein the processing circuitry is configured to: determine a predefined search area that is predefined based on dimensions of a current block within a current picture; determine one or more block vectors; determine one or more additional search areas based on the one or more block vectors; determine a prediction block for the current block based on the predefined search area and the one or more additional search areas; and reconstruct the current block based on the prediction block.

Clause 12. The device of clause 11, wherein the processing circuitry is configured to: determine template matching cost values between a current template of the current block and respective templates of prediction blocks in the predefined search area and the one or more additional search areas, wherein to determine the prediction block, the processing circuitry is configured to determine the prediction block based on the template matching cost values.

Clause 13. The device of clause 12, wherein the template matching cost values are first template matching cost values, and wherein the processing circuitry is configured to: determine additional prediction blocks based on the prediction blocks in the predefined search area and the one or more additional search areas; and determine second template matching cost values between the current template and respective templates of the additional prediction blocks, wherein to determine the prediction block, the processing circuitry is configured to determine the prediction block for the current block based on the first template matching cost values and the second template matching cost values.

Clause 14. The device of any of clauses 12 and 13, wherein one of the one or more additional search areas comprises a main subarea and other subareas, and wherein to determine template matching cost values, the processing circuitry is configured to: determine template matching cost values between the current template and respective templates of prediction blocks in the main subarea; and based on none of the template matching cost values between the current template and respective templates of prediction blocks in the main subarea satisfying a threshold, determine template matching cost values between the current template and respective templates of prediction blocks in the other subareas.

Clause 15. The device of any of clauses 12-14, wherein to determine the prediction block, the processing circuitry is configured to one of: determine the prediction block associated with the lowest template matching cost value; or construct a candidate list of prediction blocks arranged based on the respective template matching cost values, and receive an index into the candidate list that identifies the prediction block.

Clause 16. The device of any of clauses 11-15, wherein the one or more block vectors comprise one or more block vector predictors for the current block, and wherein the one or more block vector predictors are based on block vectors of neighboring blocks.

Clause 17. The device of any of clauses 11-16, wherein to determine the one or more additional search areas, the processing circuitry is configured to: determine respective center samples identified with each of the one or more block vectors; and determine respective predefined-shape areas around each of the respective center samples.

Clause 18. The device of clause 17, wherein the predefined-shape areas comprise one of a rectangular shape or a cross shape.

Clause 19. The device of any of clauses 11-18, wherein to reconstruct the current block, the processing circuitry is configured to: receive residual information indicative of a difference between the current block and the prediction block; and add the residual information to the prediction block to reconstruct the current block.

Clause 20. A device for encoding video data, the device comprising: one or more memories configured to store the video data; and processing circuitry coupled to the one or more memories, wherein the processing circuitry is configured to: determine a predefined search area that is predefined based on dimensions of a current block within a current picture; determine one or more block vectors; determine one or more additional search areas based on the one or more block vectors; determine a prediction block for the current block based on the predefined search area and the one or more additional search areas; and encode the current block based on the prediction block.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
determining a predefined search area that is predefined based on dimensions of a current block within a current picture;
determining one or more block vectors;
determining one or more additional search areas based on the one or more block vectors;
determining a prediction block for the current block based on the predefined search area and the one or more additional search areas; and
reconstructing the current block based on the prediction block.

2. The method of claim 1, further comprising:
determining template matching cost values between a current template of the current block and respective templates of prediction blocks in the predefined search area and the one or more additional search areas,
wherein determining the prediction block comprises determining the prediction block based on the template matching cost values.

3. The method of claim 2, wherein the template matching cost values are first template matching cost values, the method further comprising:
determining additional prediction blocks based on the prediction blocks in the predefined search area and the one or more additional search areas; and
determining second template matching cost values between the current template and respective templates of the additional prediction blocks,
wherein determining the prediction block comprises determining the prediction block for the current block based on the first template matching cost values and the second template matching cost values.

4. The method of claim 2,
wherein one of the one or more additional search areas comprises a main subarea and other subareas, and
wherein determining template matching cost values comprises:
determining template matching cost values between the current template and respective templates of prediction blocks in the main subarea; and
based on none of the template matching cost values between the current template and respective templates of prediction blocks in the main subarea satisfying a threshold, determining template matching cost values between the current template and respective templates of prediction blocks in the other subareas.

5. The method of claim 2, wherein determining the prediction block comprises determining the prediction block associated with the lowest template matching cost value.

6. The method of claim 2, wherein determining the prediction block comprises:
constructing a candidate list of prediction blocks arranged based on the respective template matching cost values; and
receiving an index into the candidate list that identifies the prediction block.

7. The method of claim 1, wherein the one or more block vectors comprise one or more block vector predictors for the current block, and wherein the one or more block vector predictors are based on block vectors of neighboring blocks.

8. The method of claim 1, wherein determining the one or more additional search areas comprises:
determining respective center samples identified with each of the one or more block vectors; and
determining respective predefined-shape areas around each of the respective center samples.

9. The method of claim 8, wherein the predefined-shape areas comprise one of a rectangular shape or a cross shape.

10. The method of claim 1, wherein reconstructing the current block comprises:
receiving residual information indicative of a difference between the current block and the prediction block; and
adding the residual information to the prediction block to reconstruct the current block.

11. A device for decoding video data, the device comprising:
one or more memories configured to store the video data; and
processing circuitry coupled to the one or more memories, wherein the processing circuitry is configured to:
determine a predefined search area that is predefined based on dimensions of a current block within a current picture;
determine one or more block vectors;
determine one or more additional search areas based on the one or more block vectors;
determine a prediction block for the current block based on the predefined search area and the one or more additional search areas; and
reconstruct the current block based on the prediction block.

12. The device of claim 11, wherein the processing circuitry is configured to:
determine template matching cost values between a current template of the current block and respective templates of prediction blocks in the predefined search area and the one or more additional search areas,
wherein to determine the prediction block, the processing circuitry is configured to determine the prediction block based on the template matching cost values.

13. The device of claim 12, wherein the template matching cost values are first template matching cost values, and wherein the processing circuitry is configured to:
determine additional prediction blocks based on the prediction blocks in the predefined search area and the one or more additional search areas; and
determine second template matching cost values between the current template and respective templates of the additional prediction blocks,
wherein to determine the prediction block, the processing circuitry is configured to determine the prediction block for the current block based on the first template matching cost values and the second template matching cost values.

14. The device of claim 12,
wherein one of the one or more additional search areas comprises a main subarea and other subareas, and
wherein to determine template matching cost values, the processing circuitry is configured to:
determine template matching cost values between the current template and respective templates of prediction blocks in the main subarea; and
based on none of the template matching cost values between the current template and respective templates of prediction blocks in the main subarea satisfying a threshold, determine template matching cost values between the current template and respective templates of prediction blocks in the other subareas.

15. The device of claim 12, wherein to determine the prediction block, the processing circuitry is configured to one of:
determine the prediction block associated with the lowest template matching cost value; or
construct a candidate list of prediction blocks arranged based on the respective template matching cost values, and receive an index into the candidate list that identifies the prediction block.

16. The device of claim 11, wherein the one or more block vectors comprise one or more block vector predictors for the current block, and wherein the one or more block vector predictors are based on block vectors of neighboring blocks.

17. The device of claim 11, wherein to determine the one or more additional search areas, the processing circuitry is configured to:
determine respective center samples identified with each of the one or more block vectors; and
determine respective predefined-shape areas around each of the respective center samples.

18. The device of claim 17, wherein the predefined-shape areas comprise one of a rectangular shape or a cross shape.

19. The device of claim 11, wherein to reconstruct the current block, the processing circuitry is configured to:
receive residual information indicative of a difference between the current block and the prediction block; and
add the residual information to the prediction block to reconstruct the current block.

20. A device for encoding video data, the device comprising:
one or more memories configured to store the video data; and
processing circuitry coupled to the one or more memories, wherein the processing circuitry is configured to:
determine a predefined search area that is predefined based on dimensions of a current block within a current picture;
determine one or more block vectors;
determine one or more additional search areas based on the one or more block vectors;
determine a prediction block for the current block based on the predefined search area and the one or more additional search areas; and
encode the current block based on the prediction block.
